(19) United States
(12) Patent Application Publication
(10) Pub. No.: US 2024/0364824 A1
(43) Pub. Date: Oct. 31, 2024

(54) IMAGE READING DEVICE AND IMAGE FORMING APPARATUS

(71) Applicant: KONICA MINOLTA, INC., Tokyo (JP)

(72) Inventor: Shinobu KONNO, Tokyo (JP)

(21) Appl. No.: 18/645,914

(22) Filed: Apr. 25, 2024

(30) Foreign Application Priority Data
Apr. 26, 2023 (JP) 2023-072798

(51) Int. Cl. H04N 1/00; B41J 11/00; B41J 13/08; B65H 5/06; H04N 1/401

(52) U.S. Cl. CPC H04N 1/00602; B41J 11/009; B41J 13/08; B65H 5/066; H04N 1/00665; H04N 1/00724; H04N 1/00726; H04N 1/401; B65H 2404/1521; B65H 2404/1526; B65H 2557/64; H04N 2201/0081

(57) ABSTRACT

An image reading device includes: a conveyer, and an imaging device that reads optical information on a surface of a sheet-like member being conveyed by the conveyer, in an imaging area of a predetermined range in a conveyance direction. The conveyer includes a conveyance path moving mechanism that moves a conveyance path in the imaging area so that a distance from the imaging device changes and adjusts a position of the surface of the sheet-like member to a position at a predetermined distance from the imaging device. An image forming apparatus includes: the image reading device; and an image forming section that uses the sheet-like member being conveyed by the conveyer as a recording medium and forms an image on a surface of the recording medium.

### CROSS REFERENCE TO RELATED APPLICATIONS

The present invention claims priority under 35 U.S.C. § 119 to Japanese Patent Application No. 2023-072798, filed Apr. 26, 2023, the entire content of which is incorporated herein by reference.

### BACKGROUND OF THE INVENTION

### Technical Field

The present invention relates to an image reading device and an image forming apparatus.

### Description of Related Art

There is disclosed an image forming apparatus that, in order to maintain the quality of a printed matter, includes an image reading device, such as a scanner, to capture an image of a recording medium on which an image has been formed and determines the image quality or a deviation of the image on the recording medium (see, for example, Japanese Unexamined Patent Publication No. 2017-183798). In the case of the image forming apparatus described in Japanese Unexamined Patent Publication No. 2017-183798, an image reading section (a scanner) includes an adjustment mechanism that moves a lens in an optical axis direction so as to focus on a surface of a recording medium.

Image forming apparatuses have differences in the color reproducibility of image data in the RGB color space, depending on the apparatus model, the recording agent such as ink or toner, and even in the same model, a production lot number, a machine setting such as the linear speed (printing speed), and an environment factor such as the temperature. In connection with this, there is disclosed an image forming apparatus that includes a color scanner or further includes a colorimeter and, based on a difference in the color information between a formed image and the image data, performs correction on the image data of the image to be formed on the subsequent recording medium or page to feed back the difference to the image formation (e.g., see Japanese Unexamined Patent Publication No. 2017-112451, Japanese Unexamined Patent Publication No. 2022-172540, and Japanese Patent No. 6787050).

Color imaging devices such as a color scanner and colorimeters need to periodically perform shading correction in which an image of a reference color member having a reference color (generally, white or black) on a surface thereof is captured to determine calibration data for correcting pixel values, in order to acquire accurate color information. However, when an image forming apparatus that prints on continuous recording medium, such as a roll sheet, performs shading correction, the continuous recording medium must be removed from an area (imaging area) facing an imaging device in order to place the reference color member in the imaging area. For example, when an operator opens the housing of the image forming apparatus and manually removes the continuous recording medium or cuts the continuous recording medium in the imaging area, the continuous recording medium needs to be mounted again after the shading correction, and thus the productivity decreases. In view of this, the image forming apparatuses described in Japanese Unexamined Patent Publication No. 2017-112451 and Japanese Unexamined Patent Publication No. 2022-172540 adopt a structure in which guide rollers that support a continuous recording medium in the vicinity of an imaging area are movable. When performing shading correction, these image forming apparatuses can temporarily retract the portion of the continuous recording medium stretched by these guide rollers to the outside of the imaging area and move the reference color member to the empty imaging area.

### SUMMARY OF THE INVENTION

### Problems to be Solved by the Invention

Generally, in an image forming apparatus, a scanner is arranged such that an opening face of a housing of the scanner is positioned extremely close to a recording medium, which is a subject. In addition, some image forming apparatuses can be applicable to recording media having a thicknesses of about 50 μm to about 0.5 mm. In such an image forming apparatus, the scanner is installed such that a large clearance is provided between the recording medium and the glass of the opening face of the scanner to avoid contact of them. In addition, in order to extend the focal range, the scanner is provided with a plurality of mirrors so as to extend the optical path length from a lens to the recording medium (see Japanese Unexamined Patent Publication No. 2022-172540). In such a scanner, when the lens is moved as described in Japanese Unexamined Patent Publication No. 2017-183798, the focal plane greatly moves with respect to the movement distance. Therefore, exact adjustment is required to be performed for the scanner when the recording medium is changed to one having a different thickness, making the structure of the adjustment mechanism complex. In view of this, there is room for improvement.

The present invention has been made in consideration of the above-described problems, and it is an object of the present invention to, in an image forming apparatus, capture a high-accurate image regardless of the type of the recording medium, with a simple structure.

### Means for Solving the Problem

To achieve at least one of the abovementioned objects, an aspect of the present invention is an image reading device including: a conveyer, and an imaging device that reads optical information on a surface of a sheet-like member being conveyed by the conveyer, in an imaging area of a predetermined range in a conveyance direction, wherein the conveyer includes a conveyance path moving mechanism that moves a conveyance path in the imaging area so that a distance from the imaging device changes, and adjusts a position of the surface of the sheet-like member to a position at a predetermined distance from the imaging device.

### BRIEF DESCRIPTION OF THE DRAWINGS

The advantages and features provided by one or more embodiments of the invention will become more fully understood from the detailed description given hereinbelow and the following drawings which are given by way of illustration only, and thus are not intended as a definition of the limits of the present invention:

FIG. 1 is a schematic configuration diagram of an image forming apparatus according to an embodiment of the present invention,

FIG. 2 is a configuration diagram of an image reading device according to the embodiment of the present invention, and is a partially enlarged view of FIG. 1,

FIG. 3A is a schematic diagram for explaining a shading correction operation by the conveyance path moving mechanism of the image reading device according to the embodiment of the present invention,

FIG. 3B is a schematic diagram for explaining the shading correction operation by the conveyance path moving mechanism of the image reading device according to the embodiment of the present invention,

FIG. 3C is a schematic diagram for explaining the shading correction operation by the conveyance path moving mechanism of the image reading device according to the embodiment of the present invention,

FIG. 4A is a schematic diagram for explaining an operation by the conveyance path moving mechanism of the image reading device according to the embodiment of the present invention,

FIG. 4B is a schematic diagram for explaining the operation of the conveyance path moving mechanism of the image reading device according to the embodiment of the present invention,

FIG. 5A is a configuration diagram of an image reading device according to a modification example of the embodiment of the present invention; and

FIG. 5B is a schematic diagram for explaining the shading correction operation by the conveyance path moving mechanism of the image reading device according to the modification example of the embodiment of the present invention.

### DETAILED DESCRIPTION

Hereinafter, an image forming apparatus in a mode (embodiment) for carrying out the present invention will be described with reference to the drawings. However, the scope of the invention is not limited to the disclosed embodiments.

In the drawings, the size, positional relationship, and the like of members may be exaggerated for clarity, and the shapes of the members may be simplified. Also, in the following description, identical members or members of the same quality are denoted by identical reference numerals, and description thereof is omitted as appropriate.

### Image Forming Apparatus

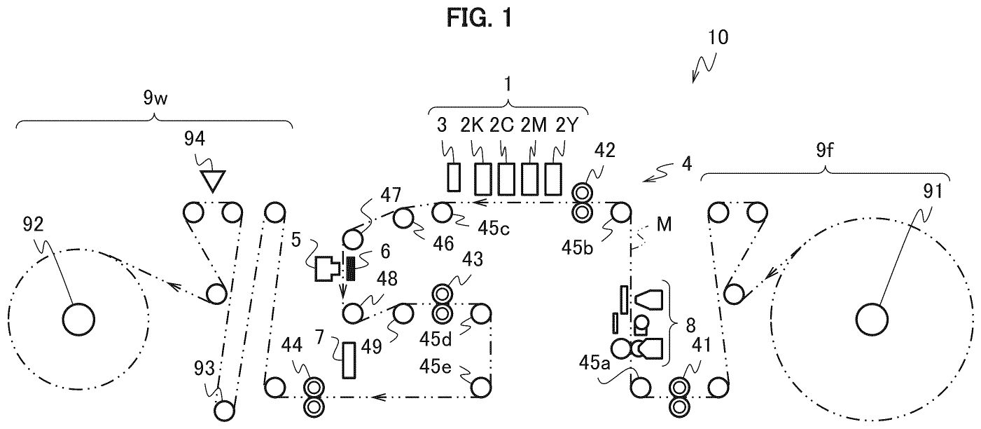

FIG. 1 is a schematic diagram of an image forming apparatus according to an embodiment of the present invention, which is a configuration diagram viewed from a side. The image forming apparatus 10 illustrated in FIG. 1 is a full-color inkjet image forming apparatus that forms a color image on the front face of a long recording medium M such as continuous sheet, with a sheet feed device 9f and a winder 9w connected thereto. As illustrated in FIG. 1, The image forming apparatus 10 includes: an image forming section 1 that forms an image on the recording medium M, a conveyance mechanism (conveyer) 4 that conveys the recording medium M, an image reading section 5 that captures an image of the recording medium M, a backing unit including a background member 6, a shading correction unit including a reference color member 7, a media sensor (recording medium detector) 8, a housing that houses these components and an operation panel installed on the outer surface of the housing, a thermometer that measures the room temperature and the temperature inside the housing, and a printer controller (not illustrated) that controls the image forming section 1, the conveyance mechanism 4, and the line.

### Recording Medium

The recording medium M, which is a material on which the image forming apparatus 10 performs printing, is a long sheet-like member and is supplied in a state of being wound around a spool (not illustrated), which is used as a tool. The recording medium M has a width supported by the image forming apparatus 10. The width is, for example, equal to or shorter than about 330 mm, which is the same as that for an image forming apparatus for flat cut sheets. The recording medium M is supplied with a length of, for example, several tens to several thousands of meters, and is cut off from an unprinted area after printing is completed. The recording medium M may be, for example, a paper or a plastic film, such as polypropylene (PP) or polyethylene terephthalate (PET), or a tack paper which is coated with an adhesive on its back surface and is peelably bonded to a release paper.

Hereinafter, components constituting the image forming apparatus 10 will be each described.

### Image Forming Section

The image forming section 1 includes head units 2Y, 2M, 2C, and 2K, and a fixing section 3. The head units 2Y, 2M, 2C, and 2K eject inks of respective colors of Y (Yellow), M (Magenta), C (Cyan), and K (Black) from nozzle holes opened in nozzle surfaces facing the recording medium M, respectively. In the case of the present embodiment, the head units 2Y, 2M, 2C, and 2K are arranged in this order from the upstream side in the conveyance direction of the recording medium M. As a result, the ink is adhered to the recording medium M in the order of Y, M, C, and K. Alternatively, the image forming section 1 may further include a head unit to eject white ink. Note that in the present specification, the terms upstream, downstream, front/forward, and rear/rearward refer to those with respect to the conveyance direction. The fixing section 3 is disposed in the vicinity of, further downstream of the head unit 2K, which is located most downstream among the head units 2Y, 2M, 2C, and 2K, and fixes the recording agent (ink) attached to the surface of the recording medium M. The fixing section 3 is provided as necessary according to the image forming method. In a case where the image forming section 1 uses, for example, a UV curable ink, the fixing section 3 is a UV light source to irradiate the recording medium M with UV light and includes UV-LEDs arranged in the conveyance width direction. Alternatively, the fixing section 3 is a heater for heating the recording medium M.

### Conveyance Mechanism

The conveyance mechanism 4 conveys the recording medium M in the direction indicated by the arrow at a predetermined speed, to cause the recording medium M to sequentially pass through the areas facing the head units 2Y, 2M, 2C, and 2K of the image forming section 1, the fixing section 3, and the image reading section 5. The conveyance mechanism 4 includes conveyance rollers 41, 42, 43, and 44, guide rollers 45a to 45e, 46, and 49, movable guide rollers 47 and 48, and motors (not illustrated) that rotationally drive the conveyance rollers 41, 42, 43, and 44. Each of the rollers 41 to 49 stretches the recording medium M in the image forming apparatus 10 and rotates around a rotation shaft extending in the conveyance width direction (the direction perpendicular to the drawing surface of FIG. 1). The conveyance rollers 41, 42, 43, and 44 each include two rollers (a pair of rollers) that sandwich the recording medium M from both sides and rotates in cooperation with each other. The conveyance rollers 41, 42, 43, and 44 may be each configured such that one of the pair of rollers is an active roller to which rotation is transmitted from a motor and the other is a driven roller or such that both are active rollers. In the image forming apparatus 10, the conveyance rollers 41, 42, 43, and 44 are disposed such that one or more of them are located upstream of the image forming section 1 and one or more of them are located downstream of the image reading section 5. A required number of conveyance rollers are further installed at positions according to the conveyance path of the recording medium M. The guide rollers 45a to 45e are driven shafts that are rotatably supported and rotate as the recording medium M is conveyed. The guide rollers 45a to 45e are provided as necessary. A required number of guide rollers are installed at positions according to the conveyance path of the recording medium M.

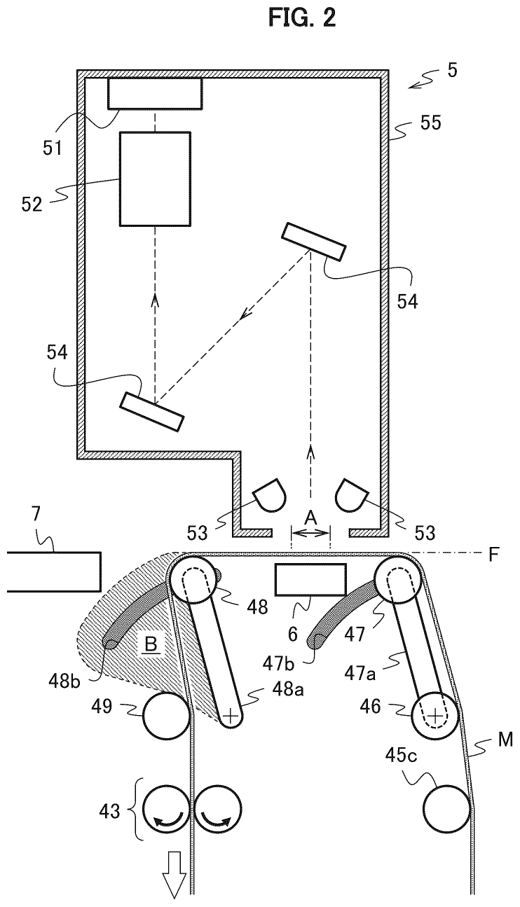

The guide rollers 46, 49 and the movable guide rollers 47, 48 constitute a conveyance path moving mechanism that supports the recording medium M in an imaging area A (see FIG. 2) where an image is captured by the image reading section 5 and in the vicinity of the front and rear of the imaging area A and moves the recording medium M along the conveyance path. As illustrated in FIG. 2, in the conveyance path moving mechanism, the rollers 46, 47, 48, and 49 are arranged in this order from the upstream side, and the movable guide rollers 47 and 48 are arranged with the imaging area A interposed therebetween in the front-rear direction. That is, the movable guide rollers 47 and 48 stretch and support the recording medium M so that the surface of the recording medium M is positioned on the focal plane F of the image reading section 5. The rollers 46, 47, and 48 abut against the back surface of the recording medium M, and the guide roller 49 abuts against the front surface of the recording medium M. Note that, in FIG. 2, FIG. 1 is rotated by 90 degrees so that the conveyance direction in the imaging area A is shown horizontally (left and right in FIG. 2). In addition, in FIG. 2, arrows indicating the rotation directions of the conveyance roller 43 are shown, and the conveyance direction of the recording medium M is indicated by the hollow arrow.

The guide rollers 46 and 49 have the same configuration as the guide roller 45a and the like. The movable guide rollers 47 and 48 are driven shafts which are rotatably supported in the same manner as the guide rollers 46 and 49, but the shafts, that is, the rotation shafts are provided so as to be movable in a predetermined range. The movable guide rollers 47 and 48 move in the thickness direction (vertical direction in FIG. 2) of the recording medium M in the imaging area A and also move in the conveyance direction in the imaging area A at the same time. In the case of the present embodiment, the both ends of the rotation shafts of the movable guide rollers 47 and 48 respectively penetrate end portions of rotatable arms 47a and 48a and are respectively supported by arc-shaped guide grooves 47b and 48b. This allows the rotation shafts of the movable guide rollers 47 and 48 to move along an arc.

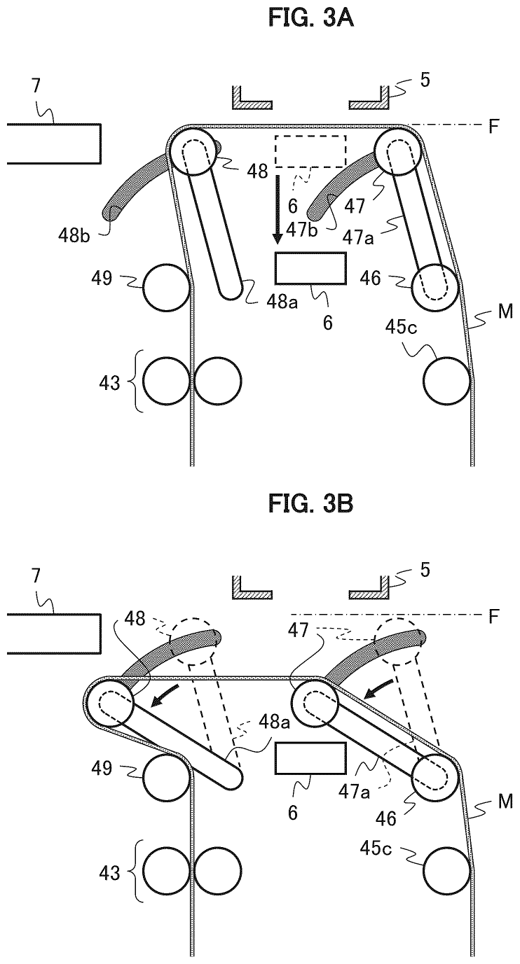

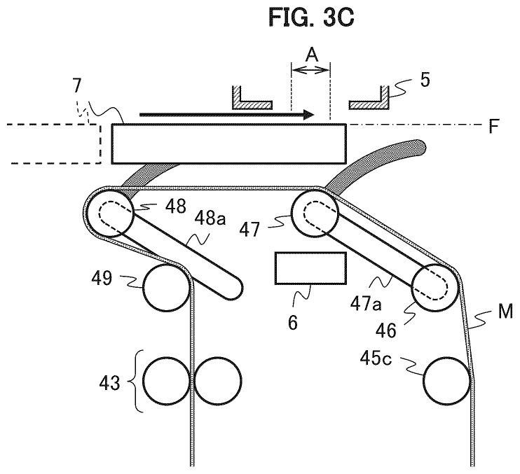

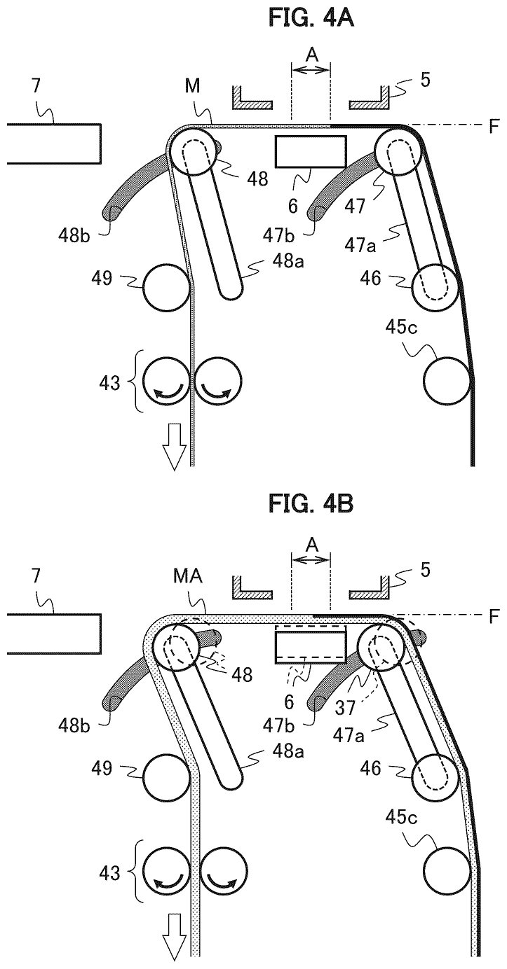

The movable range of the movable guide rollers 47 and 48 may be set as a range that meets the following conditions:
(i) When the movable guide rollers 47 and 48 are positioned at the uppermost position as illustrated in FIG. 2, the thinnest recording medium M supported by the image forming apparatus 10 can be stretched so that the surface of the recording medium M reaches the focal plane F at a predetermined distance from the image reading section 5.
(ii) In addition, when the movable guide rollers 47 and 48 are positioned at the lowermost position illustrated in FIG. 2, the reference color member 7 can be arranged in the imaging area A of the image reading section 5 without contacting the thickest recording medium MA in a state where the thickest recording medium MA (see FIG. 4B) is stretched between the movable guide rollers 47 and 48.
(iii) Furthermore, in order that the movable guide rollers 47 and 48 and the arms 47a and 47b thereof do not contact another component, for example, in the case of the present embodiment, the arm 48a does not contact the shaft of the guide roller 49 (see FIG. 3B).

The guide roller 46 is disposed at a position slightly shifted toward the back surface side (lower side in FIG. 1) of the recording medium M with respect to the upstream guide roller 45c so that the recording medium M does not float from the guide roller 45c without largely changing the conveyance direction from the upstream guide roller 45c (conveyance direction in the image forming section 1, left direction in FIG. 1, up direction in FIG. 2). The movable guide roller 47 also moves within a range such that the recording medium M is not caused to float from the guide roller 46. The movable guide roller 48 is disposed such that the conveyance direction in between the movable guide roller 48 and the movable guide roller 47 is rotated by 90 degrees with respect to the conveyance direction in the image forming section 1, and in the case of the present embodiment, the movable guide roller 48 moves in conjunction with the movable guide roller 47. The guide roller 49 is disposed such that the recording medium M stretched between the guide roller 49 and the movable guide roller 48 is parallel or substantially parallel to the recording medium M stretched between the rollers 46 and 47. In addition, a space B in which no member is present is provided in the vicinity of the outside of the rollers 48 and 49 (space opposite to the side of the rollers 46 and 47). This is to enable movement of the movable guide rollers 47 and 48 and the recording medium M supported by the rollers 46, 47, 48, and 49. The operation of the movable guide rollers 47 and 48 (conveyance path moving mechanism) will be described in detail later.

### Image Reading Section

The image reading section 5 captures an image of the recording medium M being conveyed and acquires data of the image formed on the recording medium M. As the image reading section 5, a known device can be applied (for example, see Japanese Unexamined Patent Publication No. 2017-183798 and Japanese Unexamined Patent Publication No. 2022-172540). In one example, as illustrated in FIG. 2, the image reading section 5 includes an image sensor 51, an optical element 52, light sources 53, mirrors 54, and a housing 55 that houses these components. The housing 55 has, in its face facing the recording medium M, an opening that is longer than the recording medium M in the conveyance width direction. A glass plate (not illustrated) is fitted into the opening. The image reading section 5 captures an image of a subject in the imaging area A, which is opposed to the opening of the housing 55. The image sensor 51 is a line image sensor that captures an image of an entirety (entire width) of the recording medium M in the conveyance width direction at the same time and includes an array of Charge Coupled Devices (CCDs) and the like. The image sensor 51 outputs the acquired image data to the printer controller. The optical element 52 is an optical element to form on the image sensor 51 the image located at a predetermined distance (focal plane F) from the image reading section 5 (opening of the housing 55), and includes one or a plurality of lenses. The light sources 53 emit light to the subject (recording medium M). The light sources 53 are each a linear light source in which light emitting elements such as light emitting diodes (LEDs) are arranged in the conveyance width direction. The light sources 53 are disposed in two rows on the front side and the rear side in the vicinity of the opening in the housing 55. The mirrors 54 are provided in the housing 55 in order to lengthen the optical path length from the surface of the recording medium M to the image sensor 51. The mirrors 54 are each a plane mirror which is long in the conveyance width direction. In the example illustrated in FIG. 2, simply two mirrors are provided as the mirrors 54. Since the optical path length is long, the image reading section 5 can have a long focal range (length in the direction of the optical axis).

Note that the image reading section 5 may further include an adjustment mechanism that moves the optical element 52 or some of the lenses thereof in the optical axis direction to move the focal plane F in the optical axis direction (see Japanese Unexamined Patent Publication No. 2017-183798). The image forming apparatus 10 may further include a spectral colorimeter as another image reading section 5.

### Background Member

The background member 6 is arranged on the back surface side of the recording medium M in the imaging area A. This is to, in a case where the recording medium M is a particularly thin material, a material having a white color or the like that is transparent to some extent, a transparent plastic film, or the like, when the image reading section 5 captures an image of such a recording medium M, reduce transmission of the light from the light sources 53 of the image reading section 5 so as to capture a bright image. The background member 6 is arranged so as to be spaced apart from the recording medium M by a minute clearance, for example, a predetermined clearance of 200 μm or less, so that its effect is sufficient while the background member 6 is not in contact with the recording medium M being conveyed. The background member 6 may have a length equal to or larger than the imaging area A in the conveyance direction and a length equal to or larger than the recording medium M in the conveyance width direction. The background member 6 is a member having a flat upper surface (surface facing the back surface of the recording medium M). The background member 6 exhibits a white color or black color on the upper surface. The background member 6 is supported by a not-illustrated linear motion mechanism (background member moving mechanism) that moves the background member 6 in the thickness direction of the recording medium M in the imaging area A (the vertical direction in FIG. 2). The background member 6 is capable of being moved so as not to contact the recording medium M when the movable guide rollers 47 and 48 (conveyance path moving mechanism) move and so as to keep a clearance from the recording medium M at a predetermined value at the time of capturing an image of the recording medium M.

### Reference Color Member

The reference color member 7 is a member serving as a subject of the image reading section 5 when shading correction of the image reading section 5 is performed. The reference color member 7 has an upper surface (surface facing the image reading section 5) that exhibits a reference color (white or black). The reference color member 7 is a member that has a length greater than or equal to the imaging area A in the conveyance direction and a length greater than or equal to an imaging range of the image reading section 5 in the conveyance width direction and has a flat upper surface. The reference color member 7 is supported at the position where the upper surface is on the focal plane F of the image reading section 5 by a not-illustrated linear motion mechanism (reference color member moving mechanism) that moves the reference color member 7 in the conveyance direction in the imaging area A and in its opposite direction (the right-left directions in FIG. 2). As illustrated in FIG. 2, the reference color member 7 is placed forwardly of the imaging area A while avoiding the space B (standby state) so as not to contact the recording medium M while the image reading section 5 is capturing an image of the recording medium M. The reference color member 7 is moved to the imaging area A before the image reading section 5 starts shading correction.

### Media Sensor

The media sensor 8 is a sensor that detects physical properties of the recording medium M being supplied to the image forming apparatus 10. One or more physical properties of the recording medium M may be comprehensively checked to identify the type of the recording medium M. Specific examples of the physical properties include a thickness, a basis weight, and a surface property. In the case of the present embodiment, media sensor 8 includes a thicknesses sensor, a basis weight sensor, and a surface property sensor. For each of them, it is possible to apply a known device capable of detecting the corresponding property of the recording medium M in a state of being stretched by the rollers (conveyance rollers and guide rollers) of the conveyance mechanism 4. The thickness sensor is, for example, a transmissive optical sensor of the lever encoder type. The basis weight sensor is, for example, a transmissive optical sensor and includes a plurality of LEDs and photodiodes having different wavelengths to obtain the basis weight based on the light transmissivity of the recording medium M for each of the wavelengths. The surface property sensor is, for example, a reflection-type optical sensor and detects the light reflected by specular reflection and the light reflected by diffuse reflection on the surfaces of the recording medium M to determine the degree of surface roughness and glossiness. The optical data detected by these sensors (electrical signals obtained by converting the light intensities) is output to the printer controller. The printer controller calculates the physical properties of the recording medium M based on the input signals, and, based on the physical properties, identifies a corresponding recording medium based on data of various recording media stored (registered) in advance. For example, it is possible to determine whether the sheet is paper or PP, and in the case of paper, whether the sheet is high-quality paper, recycled paper, gloss coated paper (glossy paper), matt coated paper, or special paper such as embossed paper. In the case of the image forming apparatus 10, the media sensor 8 is arranged on the upstream side of the image forming section 1. In a case where the media sensor 8 is not built in the image forming apparatus 10, the media sensor 8 may be installed as external devices between the image forming apparatus 10 and the sheet feed device 9f.

### Sheet Feed Device

The sheet feed device 9f is a device that supplies the recording medium M to the image forming apparatus 10. The sheet feed device 9f is connected to a supply port of the image forming apparatus 10 to which supply port the recording medium M is supplied. The sheet feed device 9f includes a feed roller 91, which rotates while supporting the wound recording medium M, and guide rollers (indicated by white circles without reference numerals in FIG. 1). The feed roller 91 is a support member which is rotatably supported by a rotation shaft extending in the conveyance width direction and over which a spool (not illustrated) serving as a fixture for the recording medium M is fitted and engaged. The feed roller 91 is a driven shaft that rotates counterclockwise together with the spool as the recording medium M is fed from the outer side of the wound recording medium M. The feed roller 91 may have a structure, such as a torque limiter, which applies an appropriate load to the rotation so as not to slack the recording medium M by rotating excessively with respect to the amount of the recording medium M fed by the conveyance mechanism 4 of the image forming apparatus 10. The guide rollers may have the same configuration as the guide roller 45a and the like of the conveyance mechanism 4. A required number of guide rollers are installed at positions according to the conveyance path of the recording medium M. The feed roller 91 may be an active shaft rotated by a motor. Alternatively, the sheet feed device 9f may include a conveyance roller having the same configuration as that of the conveyance roller 41 of the conveyance mechanism 4 of the image forming apparatus 10. The sheet feed device 9f may further include components like the movable guide roller 93 and the cutter 94 of the later-described winder 9w, if necessary.

### Winder

The winder 9w is a device that takes up the recording medium M, on which a image(s) have been formed by the image forming apparatus 10, by winding the recording medium M around the device. The winder 9w is connected to a discharge port of the image forming apparatus 10 from which discharge port the recording medium M is discharged. The winder 9w includes a take-up roller 92 that rotates to wind the recording medium M thereon, guide rollers (represented by white circles without reference numerals in FIG. 1), a movable guide roller 93, a cutter 94 that cuts the recording medium M, and a motor (not illustrated) that rotationally drives the take-up roller 92. The take-up roller 92 is an active shaft which is rotated around a rotation shaft extending in the conveyance width direction by receiving a rotary motion transmitted from a motor. The take-up roller 92 also serves as a support member which engages with a spool fitted thereover. The take-up roller 92 winds the recording medium M onto the spool by rotating the spool counterclockwise together with the take-up roller 92 at an appropriate rotational speed. The guide roller may have the same configuration as the guide roller 45a or the like of the conveyance mechanism 4 of the image forming apparatus 10. A required number of guide rollers are installed at positions according to the conveyance path of the recording medium M. The movable guide roller 93 is a driven shaft, as is a guide roller, but is able to be shifted within a predetermined range by being attached to one end of a tension arm (not illustrated) which is rotatable within a predetermined angle with the other end being an axis. The movable guide roller 93 is arranged so as to slack the recording medium M between two guide rollers and refrains the slack of the recording medium M between the image forming apparatus 10 and the winder 9w. The cutter 94 is provided as necessary and cuts off the portion of the recording medium M wound by the take-up roller 92 from the portion held by the conveyance mechanism 4 of the image forming apparatus 10, which is located on the upstream side. The cutter 94 includes, for example, a cutting blade that is long in the conveyance width direction, cuts the recording medium M at the installation place, and is driven by a user's operation or according to a job setting. The winder 9w may further include a conveyance roller having the same configuration as the conveyance roller 41 or the like of the conveyance mechanism 4 of the image forming apparatus 10, if necessary.

### Operation of Conveyance Path Moving Mechanism

With reference to FIGS. 2, FIG. 3A, FIG. 3B, FIG. 3C, FIG. 4A, and FIG. 4B, operation of the conveyance path moving mechanism in the image forming apparatus according to the embodiment of the present invention will be described. Here, up and down refer to up and down in these drawings. First, a description will be given of an operation for the image reading section 5 to perform shading correction from a state where the image reading section 5 illustrated in FIG. 2 is capturing an image of the recording medium M.

### Operation at the Time of Performing Shading Correction

First, as illustrated in FIG. 3A, the background member 6 is moved downward. Next, as illustrated in FIG. 3B, the movable guide rollers 47 and 48 are moved downward by rotating the respective arms 47a and 48a so as to be tilted forward. As a result, the distance between the focal plane F and the recording medium M stretched between the movable guide rollers 47 and 48 is made longer than the thickness of the reference color member 7. The moving may be performed such that, assuming that the thickest recording medium MA (see FIG. 4B) is currently stretched, the distance between the surface of the recording medium MA and the focal plane F is made longer than the thickness of the reference color member 7. Finally, as illustrated in FIG. 3C, the reference color member 7 is moved in a direction opposite to the conveyance direction to face the image reading section 5 in the imaging area A.

By such steps, it is possible to provide a space for causing the reference color member 7 to face the image reading section 5 in the imaging area A while the conveyance mechanism 4 including the rollers 46, 47, 48, and 49 keeps supporting the recording medium M. In addition, the conveyance path length extending along the rollers 46, 47, 48, and 49, that is, the length of the portion of the recording medium M stretched on the rollers 46, 47, 48, and 49 does not change. Therefore, damage such as wrinkle and tear does not occur due to the recording medium M being slackened or pulled in the opposite direction. Note that in the series of operations, at least while the movable guide rollers 47 and 48 are being moved (FIG. 3B), the rotation of the conveyance rollers 41 to 44 may be stopped to stop the conveyance of the recording medium M. After completion of the shading correction, in order to resume capturing an image of the recording medium M (and forming an image on the recording medium M), the above-described steps are performed in reverse order to revert to the state illustrated in FIG. 2.

### Operation at the Time of Replacing Recording Medium

A description will be given of an operation of the conveyance path moving mechanism when the recording medium is to be replaced with a recording medium having a different thickness. Here, the thin recording medium M illustrated in FIGS. 2 and 4A is replaced with the thick recording medium MA illustrated in FIG. 4B. First, before the recording medium MA is conveyed to reach the imaging area A, the background member 6 is lowered. Next, each of the movable guide rollers 47 and 48 is moved downward by turning the respective arms 47a and 48a down forward. As a result, when the recording medium MA is stretched between the movable guide rollers 47 and 48, the surface of the recording medium MA is positioned at the focal plane F of the image reading section 5.

Alternatively, the background member 6 and the movable guide rollers 47 and 48 are moved to positions respectively lower than the above-described positions. Thereafter, in a state where the conveyance mechanism 4 has conveyed the recording medium MA so that the recording medium MA has been stretched over the rollers 46, 47, 48, and 49, the movable guide rollers 47 and 48 are moved to position the surface of the recording medium MA at the focal plane F and then the background member 6 is raised to a position at a predetermined distance from the recording medium MA.

The positions of the movable guide rollers 47 and 48, i.e., the angles of the arms 47a and 48a, and the position of the background member 6 are set in advance according to the type, mainly the thickness, of the recording media.

In each of FIGS. 4A and 4B, the area where an image has been formed on the surface of the recording medium M or MA is indicated by a thick black line. The conveyance path length from the guide roller 46 to the imaging area A is different between the recording medium M illustrated in FIG. 4A and the recording medium MA illustrated in FIG. 4B. Therefore, if the conveyance speed is the same, the time from the image formation in the image forming section 1 to the arrival at the imaging area A differs. That is, at the time point when the image formation area of the thin recording medium M reaches the imaging area A as illustrated in FIG. 4A, the image formation area of the thick recording medium MA has already advanced in the imaging area A to some extent as illustrated in FIG. 4B. In view of this, the image forming apparatus 10 adjusts the timing of the image reading section 5 capturing the image formed by the image forming section 1, according to the type (thicknesses) of the recording medium or the positions of the movable guide rollers 47 and 48 set for the type.

As described above, the operation of the conveyance path moving mechanism of the conveyance mechanism 4 and the timing of the image reading section 5 capturing an image are to be set according to the type of the recording medium M (MA). The type of the recording medium M is identified by the printer controller when the media sensor 8 detects the physical properties of the recording medium M being conveyed on the upstream side of the image forming section 1.

Alternatively, the image forming section 1 forms, on the recording medium M, a profile image representing information on the type of the recording medium M together with the image to be printed in a job, outside the image formation area where the image to be printed in the job is to be formed, e.g., in a cutting margin. Then, the image reading section 5 captures the profile image together with the image to be printed in the job, and the printer controller identifies the type of the recording medium M based on the data of the captured profile image. The profile image may be characters such as alphanumeric characters, a barcode, or a two dimensional code.

Alternatively, before the recording medium M is supplied to the image forming apparatus 10, the profile image may have been formed thereon by printing or handwriting or a label on which the profile image is displayed may have been attached thereto.

In the cutting margin of the recording medium M, an image formation adjustment image (for example, a stripe pattern) may be formed by the image forming section 1 or may be formed in advance. The image reading section 5 may perform image formation adjustment based on the data obtained by capturing the image formation adjustment image. The profile image may also serve as the image formation adjustment image.

The image forming apparatus 10 may have a configuration in which the image reading section 5, the background member 6 (backing unit), and the reference color member 7 (shading correction unit) are not incorporated. In this case, an image reading device (portion illustrated in FIG. 2) includes the image reading section 5, the background member 6, the reference color member 7, and the conveyance mechanism including the rollers 46, 47, 48, and 49 (conveyance path moving mechanism) and the conveyance roller 43 that support and convey the recording medium M in the imaging area A. The image reading device is installed as an external device between the image forming apparatus 10 and the winder 9w.

In the case of the present embodiment, the reference color member 7 is disposed forwardly of the imaging area A in the standby state but may be disposed rearwardly thereof. In addition, the movement of the reference color member 7 by the reference color member moving mechanism is not limited to the linear movement in the conveyance direction and the direction opposite thereto. For example, the reference color member moving mechanism may be such that the reference color member 7 is supported by a rotating arm and is arranged, in its standby state, at a position lower than that at the time of the shading correction. The above-described arrangement of the reference color member 7 in the standby state is appropriately designed according to the space and the like in the image forming apparatus 10. The reference color member 7 may exhibit the reference color at least in an area corresponding to the conveyance direction length of the imaging area A rather than the entire upper surface. Therefore, the reference color is not limited to only one color of white or black. The reference color member 7 may have, on the upper surface thereof, a white area and a black area arranged side by side in the conveyance direction. Then, the reference color member 7 may be shifted in the conveyance direction to arrange the area of a desired reference color in the imaging area A (see Japanese Unexamined Patent Publication No. 2017-112451). Further, the reference color member 7 may have, on the upper surface thereof, in an area other than the area exhibiting the reference color, an image for image formation adjustment of the image reading section 5.

The movement of the background member 6 by the background member moving mechanism is not limited to the linear movement in the up-down directions. The background member moving mechanism may be configured to move the background member 6 along an arc in conjunction with the movable guide rollers 47 and 48. In this case, the background member 6 has a sufficient length in the conveyance direction so as to be arranged over the entire imaging area A except for the time of shading correction. In addition, like the above-described reference color member 7, the background member 6 may have, on the upper surface thereof, a white area and a black area arranged side by side in the conveyance direction, to be used according to the type of the recording medium M or the like. Such a background member 6 is also configured movable in the conveyance direction (see Japanese Unexamined Patent Publication No. 2017-112451).

In the case of the present embodiment, the conveyance path moving mechanism of the conveyance mechanism 4 is configured such that the movable guide rollers 47 and 48 move in conjunction with each other. The movable guide rollers 47 and 48 may further be configured movable independently of each other. With such a configuration, it is possible to correct inclination, or the like of the recording medium M stretched between the movable guide rollers 47 and 48. Furthermore, one or both of the movable guide rollers 47 and 48 may each be configured such that both ends thereof in the conveyance width direction are independently movable. For this purpose, for example, the movable guide roller 47 may be configured such that the arms 47a supporting both ends of the shaft can be rotated independently of each other. The same applies to the movable guide roller 48.

In the case of the present embodiment, the conveyance path moving mechanism of the conveyance mechanism 4 is configured such that the movable guide rollers 47 and 48 move forward and downward in FIG. 2 but may be configured such that they move rearward. In this case, the guide roller 46 on the upstream side is disposed so as to abut on the front surface of the recording medium M, and the guide roller 49 on the downstream side is disposed so as to abut on the back surface of the recording medium M. Therefore, the front surface of the recording medium M comes into contact with the guide roller 46 soon after an image is formed on the recording medium M by the image forming section 1. Depending on the image forming method, a recording agent such as ink or toner may not be sufficiently fixed to the recording medium M, and the recording agent may separate from the recording medium M when a component such as a guide roller contacts the surface of the recording medium M. In view of this, the image forming section 1 and the image reading section 5 may be arranged such that the length of the conveyance path between the two is long, or an air blower fan or the like may be provided therebetween, to promote fixing of the recording agent (see Japanese Unexamined Patent Publication No. 2022-172540).

The image forming apparatus 10 may be one that adopt the electrophotographic method implemented by a laser printer or the like. In this case, the image forming section 1 includes, in place of the head units, photosensitive drums of colors Y, M, C, and K, as well as an intermediate transfer belt. Furthermore, the fixing section 3 includes rollers that sandwich the recording medium M from both sides and applies pressure and heat to the recording medium M. Therefore, the recording medium M reaches a high temperature due to image formation. The luminance read by the image sensor 51 of the image reading section 5 changes depending on the temperature. Therefore, the image forming apparatus 10 may include a thermometer that measures the temperature in the vicinity of the imaging area A or the surface temperature of the recording medium M and correct the data of the image captured by the image sensor 51 according to the temperature (see Japanese Patent No. 6787050). Alternatively, as described above, an air blower fan may be provided between the image forming section 1 and the image reading section 5 to cool the recording medium M (see Japanese Unexamined Patent Publication No. 2022-172540).

### MODIFICATION EXAMPLE

The present invention is not limited to the above-described embodiments and can be implemented with modifications without departing from the spirit and scope of the present invention, and for example, the following aspects are included.

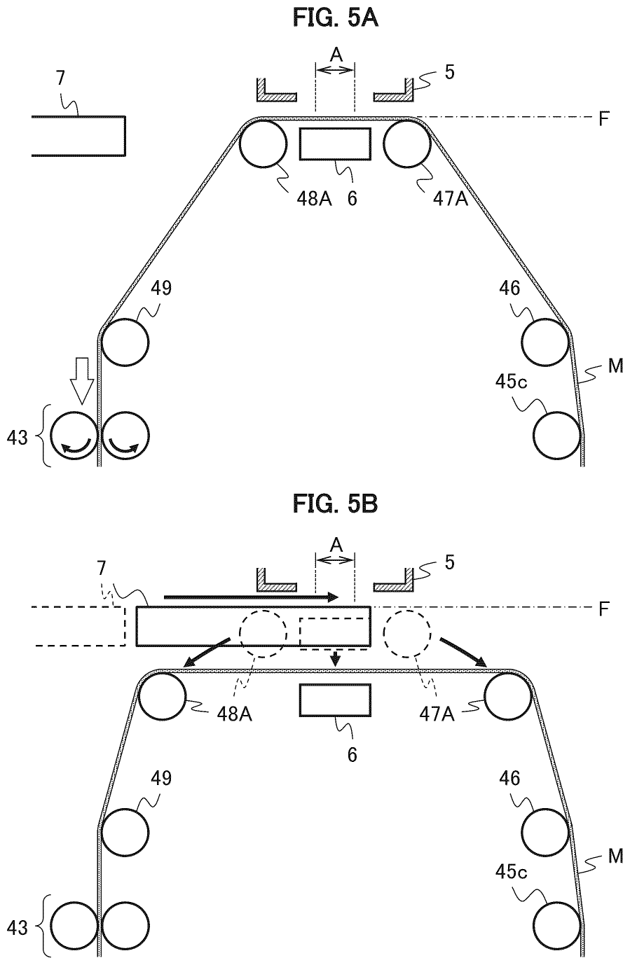

An image forming apparatus 10 according to a modification example of the embodiment has the same configuration as the embodiment except for the conveyance path moving mechanism of the conveyance mechanism 4. As illustrated in FIG. 5A, the conveyance path moving mechanism according to the present modification example includes the rollers 46, 47A, 48A, and 49 in order from the upstream side such that the rotation shafts of the rollers 46, 47A, 48A, and 49 are disposed at the apexes of an isosceles trapezoid, and a straight line connecting the rotation shafts of the movable guide rollers 47A and 48A corresponds to the shorter base of the isosceles trapezoid. Furthermore, all the rollers 46, 47A, 48A, and 49 contact the back surface of the recording medium M.

Like the movable guide rollers 47 and 48 in the case of the above-described embodiment, the shafts of the movable guide rollers 47A and 48A, i.e., the rotation shafts thereof, are movable within a predetermined range. In this modification example, the movable guide roller 47A and the movable guide roller 48A move symmetrically in the front-rear directions. At the time of performing the shading correction, as illustrated in FIG. 5B, the movable guide rollers 47A and 48A are moved downward along a gentle curve while widening the distance between the movable guide rollers 47A and 48A back and forth. As a result, the length of the conveyance path along the rollers 46, 47A, 48A, and 49 does not change, and the movable guide rollers 47A and 48A move downward together with the recording medium M stretched therebetween, so that the reference color member 7 can be moved to the conveyance area A. Note that, in a similar way to the above-described embodiment, the background member 6 is moved downward before or at the same time as moving the movable guide rollers 47A and 48A.

The moving of movable guide rollers 47A and 48A according to the type of the recording medium M can be performed in a similar way to the manner described above. In this modification example, as the movable guide roller 47A and the movable guide roller 48A move symmetrically in the front-rear directions, the length of the conveyance path from the guide roller 46 to the imaging area A does not change. Therefore, in the case of the image forming apparatus 10 according to the present modification example, it is not necessary to adjust the timing of the image reading section 5 capturing the image formed by the image forming section 1 according to the type of recording medium and/or the positions of the movable guide rollers 47A and 48A. Further, none of the rollers 46, 47A, 48A, and 49 comes into contact with the front side of the recording medium M, and no contact occurs on the front surface of the recording medium M until the recording medium M reaches the conveyance roller 43 located on the downstream side. Therefore, regardless of the image forming method, it is not necessary to configure the image forming apparatus 10 so as to arrange the image forming section 1 and the image reading section 5 with a long conveyance path length therebetween, thus allowing a compact structure.

Although embodiments of the present invention and modifications of the embodiments have been described and illustrated in detail, the disclosed embodiments and modifications are made for purposes of illustration and example only and not limitation. The scope of the present invention should be interpreted by the terms of the appended claims.

What is claimed is:

1. An image reading device comprising:
a conveyer, and
an imaging device that reads optical information on a surface of a sheet-like member being conveyed by the conveyer, in an imaging area of a predetermined range in a conveyance direction,
wherein the conveyer comprises a conveyance path moving mechanism that moves a conveyance path in the imaging area so that a distance from the imaging device changes, and
adjusts a position of the surface of the sheet-like member to a position at a predetermined distance from the imaging device.

2. The image reading device according to claim 1, further comprising:
a shading correction unit comprising a reference color member and a reference color member moving mechanism that moves the reference color member between an inside and an outside of the imaging area,
wherein the conveyance path moving mechanism moves the sheet-like member to a position where the sheet-like member does not contact the reference color member arranged in the imaging area.

3. The image reading device according to claim 2,
wherein the conveyance path moving mechanism moves the conveyance path without changing a conveyance path length.

4. The image reading device according to claim 2,
wherein the reference color member has an image formation adjustment image outside the imaging area at a time of performing shading correction of the imaging device, and
wherein the shading correction unit moves the reference color member so that the image formation adjustment image is arranged in the imaging area.

5. The image reading device according to claim 3,
wherein the conveyer further comprises rollers that rotate while supporting the sheet-like member on peripheral surfaces of the rollers, the rollers being disposed at two positions between which the imaging area is sandwiched in a conveyance direction, and
wherein the conveyance path moving mechanism moves the conveyance path by moving a rotation shaft of at least one of the rollers.

6. The image reading device according to claim 5,
wherein the at least one of the rollers of the conveyer has one end and the other end in a conveyance width direction and the one end and the other end are movable independently of each other.

7. The image reading device according to claim 1, further comprising:
a background member having a conveyance width direction length equal to or longer than a conveyance width direction length of the sheet-like member; and
a background member moving mechanism that moves the background member,
wherein, when the imaging device captures an image of the sheet-like member, the background member moving mechanism moves the background member according to the movement of the conveyance path by the conveyance path moving mechanism so as to face, in the imaging area, a back surface of the sheet-like member with a predetermined distance spaced apart from the back surface.

8. An image forming apparatus comprising:
the image reading device according to claim 1; and
an image forming section that uses the sheet-like member being conveyed by the conveyer as a recording medium and forms an image on a surface of the recording medium.

9. The image forming apparatus according to claim 8,
wherein the recording medium is a continuous recording medium that is long in the conveyance direction.

10. The image forming apparatus according to claim 9, p1 wherein the conveyance path moving mechanism adjusts the distance of the conveyance path from the imaging device based on a type of the recording medium being conveyed.

11. The image forming apparatus according to claim 10,
wherein the recording medium has formed thereon a profile image including information on the type of the recording medium, and
wherein the information on the type of the recording medium is acquired by the imaging device capturing the profile image.

12. The image forming apparatus according to claim 11,
wherein the image forming section forms, together with an image to be printed in a job being performed, the profile image including information on the type of the recording medium outside an image formation area of the recording medium where the image to be printed is formed.

13. The image forming apparatus according to claim 9,
wherein the recording medium has an image formation adjustment image formed thereon, and p1 wherein the imaging device performs image formation adjustment by capturing the image formation adjustment image.

14. The image forming apparatus according to claim 10, further comprising:
a recording medium detector that detects physical properties of the recording medium being conveyed to the image forming section, and
wherein information on the type of the recording medium is acquired based on the physical properties detected by the recording medium detector.

15. The image forming apparatus according to claim 10,
wherein the conveyance path moving mechanism moves the conveyance path so that the distance from the imaging device changes and that at the same time the conveyance path is moved in the conveyance direction in the imaging area.

16. The image forming apparatus according to claim 15,
wherein the imaging device adjusts a timing of capturing an image of the recording medium according to the position of the conveyance path moved by the conveyance path moving mechanism.
